(19) United States
(12) Patent Application Publication
(10) Pub. No.: US 2023/0028272 A1
(43) Pub. Date: Jan. 26, 2023

(54) EXHAUST VALVE

(71) Applicant: FAURECIA SYSTEMES D'ECHAPPEMENT, NANTERRE (FR)

(72) Inventor: Lévi TALLARON, Dampierre-Sur-Le-Doubs (FR)

(21) Appl. No.: 17/867,786

(22) Filed: Jul. 19, 2022

(30) Foreign Application Priority Data
Jul. 21, 2021 (FR) 21 07843

(51) Int. Cl. F02M 26/70; F02M 26/73; F16K 1/22; F16K 27/02

(52) U.S. Cl. CPC F02M 26/70; F02M 26/73; F16K 1/224; F16K 27/0218; F02M 2026/001

(57) ABSTRACT

An exhaust valve comprises a tubular body extending along an axis, and defining a flow section perpendicular to the axis, a flap arranged in the tubular body across the flow section, and a shaft rigidly connected to the flap. The shaft is rotatable between a closed orientation in which the flap closes the flow section and an open orientation in which the flap frees the flow section. A proximal, respectively distal, housing is rigidly connected to the tubular body and houses a proximal, respectively distal, bearing ensuring a rotary interface between the tubular body and a proximal, respectively distal, end of the shaft. A rotary actuator is capable of moving the shaft alternately between the closed orientation and the open orientation, and is arranged outside the tubular body and rigidly connected to the proximal end of the shaft. The proximal and/or distal housing is separate from the tubular body.

### CROSS-REFERENCE TO RELATED APPLICATIONS

This application is a U.S. non-provisional application claiming the benefit of French Application No. 21 07843, filed on Jul. 21, 2021, which is incorporated herein by reference in its entirety.

### TECHNICAL FIELD

The disclosure relates to an exhaust valve, such as that used in an exhaust line downstream of an internal combustion engine. Such a valve can typically be used:
in connection with a tap of said line, to selectively take at least part of the exhaust gases to an exhaust gas recirculation (EGR) circuit,
in a bypass mode, to direct all or part of the exhaust gases to a heat recovery device, another circuit, or a sound attenuation device, and/or
as a device for generating back pressure for acoustic purposes.

### BACKGROUND

An exhaust valve is known to comprise a substantially tubular body, extending along an axis of extension, defining a flow section substantially perpendicular to the axis of extension. Such a valve further comprises a flap, arranged in the body across the flow section. Such a valve further comprises a shaft, rigidly connected to the flap, rotatable about an axis of rotation, passing through the body, substantially perpendicular to the axis of extension, between a closed orientation in which the flap is arranged to close off the flow section and an open orientation in which the flap is arranged to at least partially free the flow section. Such a valve further comprises either a proximal housing rigidly connected to the body, adapted to receive a proximal bearing providing the rotational interface between the body and a proximal end of the shaft, or a distal housing rigidly connected to the body, adapted to receive a distal bearing providing the rotational interface between the body and a distal end of the shaft or both. Such a valve further comprises a rotary actuator, capable of moving the shaft alternately between its closed and open orientation, arranged outside the body, rigidly connected to the proximal end of the shaft.

The disadvantage of such a valve is that it usually produces a squeaking noise in the bearings, particularly because the bearings are subjected to very high temperatures. Indeed, the temperatures encountered in an exhaust line can be on the order of 600° C. to 1000° C. As the bearing housings are usually made of the same material as the valve body, the bearings are subject to these same temperatures.

In order to solve the problem of squeaking, it is known to use self-lubricating graphite, PTFE or bronze bearings which have the advantage of being silent. However, such a bearing may degrade at 600° C. and above.

In order to cool at least the bearings, it is known to circulate a fluid, gas or liquid, in their vicinity, by using a dedicated circuit. However, such equipment is very expensive and complex, as it adds a circuit and requires the valve to be connected/disconnected at each installation/removal.

### SUMMARY

The disclosure aims to provide an alternative solution to maintain a bearing in an acceptable temperature range.

Therefore, the disclosure proposes on the one hand to protect a bearing against the effects of heat from the exhaust valve and on the other hand to cool the bearing.

To this end, one object of the disclosure is an exhaust valve, comprising a substantially tubular body along an axis of extension, defining a flow section substantially perpendicular to the axis of extension, a flap, disposed in the tubular body across the flow section, a shaft rigidly connected to the flap, rotatable about an axis of rotation, passing through the tubular body, substantially perpendicular to the axis of extension, between a closed orientation in which the flap is arranged to close off the flow section and an open orientation in which the flap is arranged to at least partially free the flow section, a proximal housing rigidly connected to the tubular body, capable of receiving a proximal bearing ensuring the rotary interface between the tubular body and a proximal end of the shaft and/or a distal housing rigidly connected to the tubular body, capable of receiving a distal bearing ensuring the rotary interface between the tubular body and a distal end of the shaft and a rotary actuator, capable of moving the shaft alternately between its closed orientation and its open orientation, disposed outside the body, rigidly connected to the proximal end of the shaft, wherein a housing is separate from the tubular body and at least one thermal decoupler is interposed between a housing and the tubular body.

Particular features or embodiments, which may be used alone or in combination, are:
the distance between the housing and the tubular body is between 2 mm and 10 mm, preferably between 3 mm and 6 mm and even more preferably between 3 mm and 5 mm,
said at least one thermal decoupler comprises at least one washer made of a thermal insulating material, resistant to high temperatures, preferably mica-based,
said at least one thermal decoupler comprises at least one thermal insulating material, such as a fiber mat, preferably of glass or ceramic,
said at least one thermal decoupler comprises an air gap in which no exhaust gas flows,
the tubular body is thinned with respect to a housing, relative to its average thickness, by a ratio of between 20 and 80%, preferably between 30 and 60% and even more preferably equal to 50%,
a housing is extended by a cooling fin, preferably disc-shaped, even more preferably perpendicular to the axis of rotation,
one housing is made of a highly heat-conductive material, preferably aluminum,
the proximal housing has a large contact surface with the rotary actuator and/or with a support of the rotary actuator,
the shaft is hollow and at least one end of the shaft opens out of the tubular body, one housing has an aperture suitable for mounting a bearing, said aperture being directed away from the tubular body,
the proximal and/or distal bearing comprises a self-lubricating graphite, PTFE or bronze bearing.

In a second aspect of the disclosure, an exhaust line comprising at least one such exhaust valve.

In a third aspect of the disclosure, a vehicle comprising at least one such exhaust line.

### BRIEF DESCRIPTION OF THE DRAWINGS

The disclosure will be better understood upon reading the following description, given only as an example, and with reference to the attached drawings, in which:

FIG. 1 shows a perspective view of an embodiment of an exhaust valve according to the disclosure;

FIG. 2 shows, in perspective view, from another point of view, the exhaust valve of FIG. 1;

FIG. 3 is a detailed schematic view of the exhaust valve of FIG. 1;

FIG. 4 shows a cutaway view of an embodiment with a solid shaft;

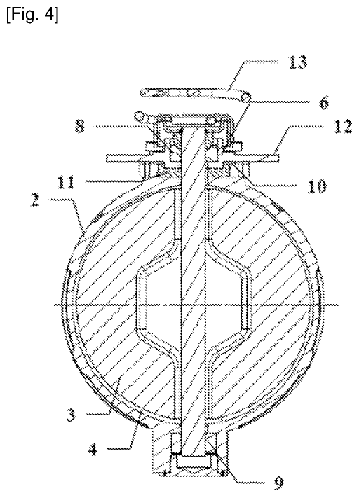

FIG. 5 shows a cutaway view of an embodiment with a hollow shaft; and

FIG. 6 shows a cutaway view of an embodiment with a thinned body.

### DETAILED DESCRIPTION

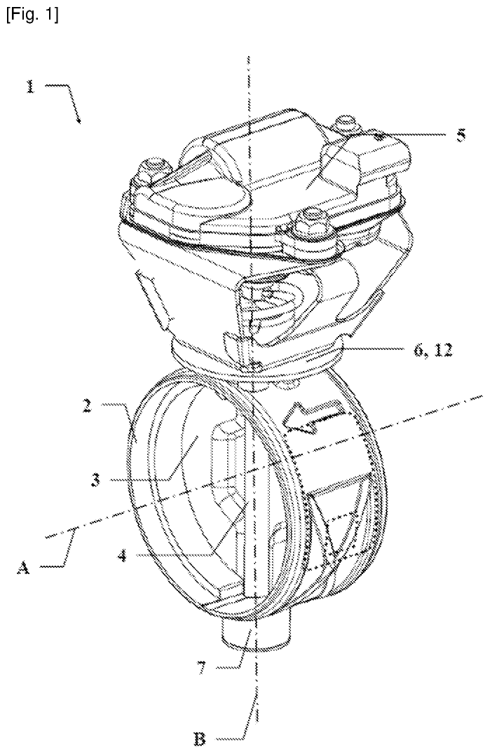

With reference to FIG. 1, 2 or 3, an exhaust valve 1 according to one embodiment of the disclosure, comprises a body 2, a flap 3, a shaft 4, a proximal housing 6 and/or a distal housing 7, and an actuator 5.

The valve body 2 is substantially tubular. It extends along an axis of extension A. The body 2 defines a flow section substantially perpendicular to, and advantageously centered on, the axis of extension A. This flow section can be any shape; however it is preferably elliptical and even more preferably circular.

The flap 3 is arranged in the body 2 across the flow section. It has a flap section that is fully inscribed in the flow section. Preferably, this flap section reproduces the flow section with a homothety factor close to 1 per lower value.

The shaft 4 is rigidly connected to the flap 3. It is rotatable about an axis of rotation B. The axis of rotation B passes through the body 2 and is substantially perpendicular to the axis of extension A. It thus passes substantially in the middle of the body 2. The rotation of the shaft 4, and thus of the rigidly connected flap 3, allows the latter to alternate between a closed orientation where the flap 3 is arranged to close the flow section and an open orientation where the flap 3 is in another orientation and is arranged to free, at least partially, the flow section.

On either side of the body 2 relative to the axis of extension A, one or two housings 6, 7 each accommodate a bearing 8, 9, which allows the shaft 4 to rotate relative to the body 2. In one embodiment, only one of the distal housing 7 and its distal bearing 9 or the proximal housing 6 and its proximal bearing 8 can be used.

The terms proximal and distal are defined here in relation to the actuator 5. A proximal housing 6 rigidly connected to the body 2 accommodates a proximal bearing 8 which provides the rotational interface between the body 2 and a proximal end of the shaft 4, located at the top in the Figures. A distal housing 7 rigidly connected to the body 2 accommodates a distal bearing 9 which provides the rotational interface between the body 2 and a distal end of the shaft 4, located at the bottom in the Figures.

The rotatable actuator 5, 14 comprises an output power take-off engaged with one end of the shaft 4 so that the shaft 4 can be moved alternately between its closed and open orientations. The actuator 5, 14 is located outside the body 2. It is rigidly connected to the proximal end of the shaft 4, advantageously via a transmission spring 13, in order to filter vibrations and reduce heat transmission from the shaft 4 to the actuator 5.

In order to reduce squeaking, at least for one bearing 8, 9, it is advantageous to use a self-lubricating graphite, PTFE or bronze bearing. This is only possible if the temperature at the bearing 8, 9 remains below a threshold temperature for degradation of such a bearing, i.e. 600° C. for such a bearing.

To this end, the disclosure proposes several ways that can be used alternatively or additionally in order to act in two manners: on the one hand, by reducing, through thermal decoupling, the heat reaching the housing 6, 7 and/or the bearing 8, 9 and, on the other hand, by reducing, through cooling, the heat present at said housing 6, 7 and/or bearing 8, 9.

In contrast to the prior art, where a housing is conventionally made of the same material as the body 2, according to a first feature, aimed at thermal decoupling, a housing 6, 7 is separate from the body 2. This means that the said housing 6, 7 is made as a separate part, which is then assembled with the body 2. This assembly can be done by any way such as by using at least one screw 15, as illustrated. It is still possible to assemble by riveting, crimping, welding, etc.

A first way of achieving thermal decoupling between the housing 6, 7 and the body 2 is to separate the housing 6, 7 from the body 2. This separation is advantageously achieved over the majority of the surface of the housing 6, 7 facing the body 2. In practice, the contact between the housing 6, 7 and the body 2 is reduced to a strict minimum, namely the surface for the attachment, such as screws 15, to achieve the assembly between the housing 6, 7 and the body 2. This reduces the exposure of the housing 6, 7 to conductive heat transfer from the body 2.

Another way to achieve thermal decoupling is to move the housing 6, 7 away from the body 2. Also, according to a further feature, made possible by the first separation feature, a gap is provided between the housing 6, 7 and the body 2. This gap, in order to provide a sensitive thermal feature, is preferably at least 2 mm, and even more preferably at least 3 mm. In order not to increase the expansion of the valve excessively, this distance is at most 10 mm, preferably 6 mm and even more preferably 5 mm.

Another way of achieving thermal decoupling is to interpose at least one thermal decoupler 10, 11 between the housing 6, 7 and the body 2.

The thermal decoupler can be a gasket or washer 10 made of a thermal insulating material, resistant to high temperatures. Such a material is preferably mica-based. It must be able to withstand a temperature of 900 to 1000° C. Examples of commercial names of candidate materials are: Gogemica HT710, consisting of 90% phlogolite mica flakes or Garlock THERMa-PUR 4122, of unknown composition, comprising the patented material with the commercial name THERMa-PUR.

This washer 10 is advantageously inserted between the housing 6, 7 and the body 2, preferably at least at the level of their attachment and contact.

Alternatively or additionally, the thermal decoupler may comprise a thermal insulating material, such as a fiber mat 11. Such a mat is made from fibers, preferably glass or ceramic. It is arranged between the housing 6, 7 and the body 2 and advantageously fills/replaces the entire air volume between the housing 6, 7 and the body 2. As illustrated, the fiber mat 11 is in the form of a substantially disc-shaped pellet 23.5 mm in diameter and 4.1 mm thick, before assembly. Assembling the housing 6, 7 slightly reduces the thickness of the fiber mat 11.

The thermal decoupler may alternatively or additionally comprise an air gap. In order for this air gap to be thermally efficient, the exhaust gases do not flow through this air gap.

The three previous thermal decouplers have the same objective: To limit the heat transfer from the exhaust gases in the body 2 to the housing 6, 7. The washer 10 acts by reducing thermal conduction, while the fiber mat 11 acts by reducing convection and thermal radiation.

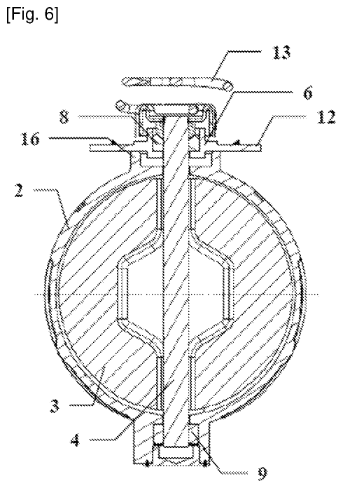

In a further feature, more particularly illustrated in FIG. 6, the body 2 is thinned with respect to a housing 6, 7. This is to reduce the thermal inertia of the body 2 in the vicinity of the housing 6, 7. This thinning is applied opposite a housing 6, 7, in the part 16 interfacing with the housing 6, 7, more particularly visible in FIG. 6. This is relative to the average thickness of the body 2. The thinning ratio is between 20 and 80%, preferably between 30 and 60% and even more preferably 50%. For example, for an average thickness of 6 mm, a thinned thickness of between 1 and 5 mm and preferably 2 mm.

All of the above decouplers are intended to achieve thermal decoupling to prevent heat transmitted from the exhaust gases to the body 2 from migrating to the housing 6, 7.

The following features also aim to cool the housing 6, 7.

A first feature is conformation. According to a further feature, the housing 6, 7 is shaped to cool as much as possible on contact with the ambient air. This increases the heat exchange surface. Furthermore, a housing 6, 7 is advantageously extended by at least one cooling fin 12. In a preferred embodiment, as illustrated, this fin 12 is disc-shaped. This disc is preferably substantially perpendicular to the axis of rotation B. The radial extent of the vane 12 is as large as possible, without substantially exceeding a total volume of space allocated to the valve 1.

Another feature is the material. According to a further feature, again aimed at cooling the housing 6, 7, said housing 6, 7 is made of a highly heat-conductive material, preferably aluminum. Thus the housing 6, 7 acts as a heat exchanger cooling itself upon contact with the surrounding air.

Preferably, aluminum grade 6000 or 6085 is used.

Advantageously, the aluminum housing 6, 7 is painted in order to increase its thermal emissivity as much as possible. This is best done with a black paint and even more preferably with a non-conductive paint to form a dielectric.

Another feature is the shape, in order to benefit from the help of the neighboring room. In a further feature, the proximal housing 6 is shaped to have a large contact surface with the actuator 5 and/or its support 14. Thus, the proximal housing 6 is substantially in optimized thermal conduction with said actuator 5 and utilizes the surface of the actuator 5 and/or the surface of its support 14 to increase its heat exchange surface with the environment. This increases the cooling capacity of the proximal housing 6. It should be noted that this feature is only available to the proximal housing 6 near the actuator 5 and not to the distal housing 7.

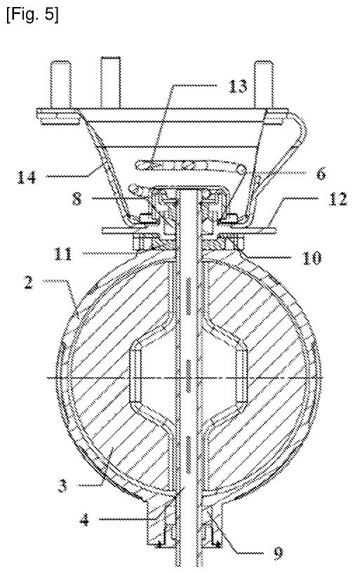

According to a further feature, more particularly illustrated in FIG. 5, aimed at reducing the heat potentially transmitted by the exhaust valve 1 to the housing 6, 7, the shaft 4 is hollow and optionally at least one of its ends is open and opens out of the body.

A housing 6, 7, comprises a cavity suitable for accommodating a bearing 8, 9. According to another feature, the housing 6, 7 is preferably oriented so that said cavity has its opening directed away from the body 2. Thus, on the side facing the body 2, the bearing 8, 9 is protected by a material web, limiting at least the heat radiation to the bearing 8, 9 housed in the housing 6, 7.

These different thermal improvement features can be used alone or in combination.

The use of some of these features can significantly reduce the temperature at a bearing 8, 9 by a large amount. For example, with a body 2 temperature of 680° C., a temperature of only 425° C. can be observed at a bearing 8, 9, which is a reduction of −255° C. or −37%. It is thus possible to maintain a housing 6, 7 at a low temperature, 425° C., which is well below the degradation temperature of a graphite bearing. Also, it is possible to use a graphite bearing and solve the squeaking problem.

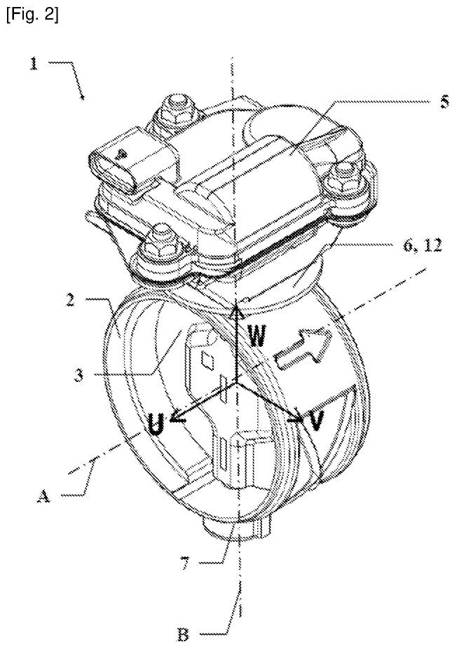

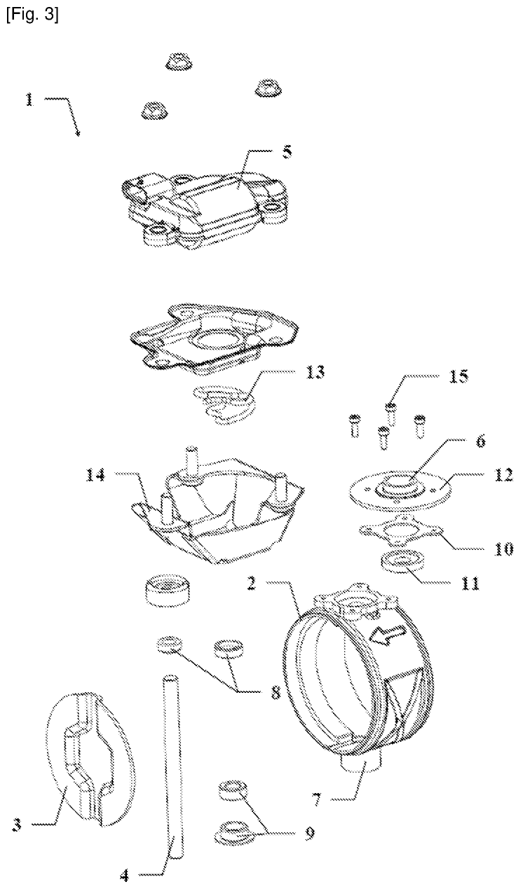

It should be noted that in the embodiment shown in FIGS. 1-3, the features of the disclosure are present only in the proximal housing 6. The features of the disclosure may of course be applied to the distal housing 7 alone or to both housings 6, 7 independently in any desired combination, different features being used for one or the other housing 6, 7.

The disclosure further relates to an exhaust line comprising at least one such exhaust valve 1.

The disclosure further relates to a vehicle comprising at least one such exhaust line.

The disclosure has been illustrated and described in detail in the drawings and the preceding description. This should be considered as illustrative and by way of example and not as limiting the disclosure to this description alone. Numerous other embodiments are possible.

### LIST OF REFERENCE SIGNS

1: valve,
2: body,
3: flap,
4: shaft,
5: actuator,
6: proximal housing,
7: distal housing,
8: proximal bearing,
9: distal bearing,
10: washer,
11: fiber mat,
12: fin,
13: spring,
14: support,
15: screw,
16: part of the body,
A: axis of extension,
B: axis of rotation.

1. An exhaust valve, comprising:
a tubular body extending along an axis of extension and defining a flow section perpendicular to the axis of extension;
a flap, disposed in the tubular body across the flow section;
a shaft rigidly connected to the flap and rotatable about an axis of rotation, the shaft passing through the tubular body and being perpendicular to the axis of extension wherein the shaft is rotatable between a closed orientation in which the flap is arranged to close off the flow section and an open orientation in which the flap is arranged to at least partially free the flow section;
a proximal housing rigidly connected to the tubular body and capable of receiving a proximal bearing ensuring a rotary interface between the tubular body and a proximal end of the shaft, and/or a distal housing rigidly connected to the tubular body and capable of receiving a distal bearing ensuring a rotary interface between the tubular body and a distal end of the shaft;
a rotary actuator that is capable of moving the shaft alternately between the closed orientation and the open orientation, wherein the rotary actuator is disposed outside the tubular body and rigidly connected to the proximal end of the shaft;
the proximal and/or distal housing is separate from the tubular body; and
at least one thermal decoupler is interposed between the proximal and/or distal housing and the tubular body.

2. The exhaust valve according to claim 1, wherein a distance between the proximal and/or distal housing and the tubular body is between 2 mm and 10 mm.

3. The exhaust valve according to claim 1, wherein a distance between the proximal and/or distal housing and the tubular body is between 3 mm and 6 mm.

4. The exhaust valve according to claim 1, wherein a distance between the proximal and/or distal housing and the tubular body is between 3 mm and 5 mm.

5. The exhaust valve according to claim 1, wherein the at least one thermal decoupler comprises at least one washer of a thermal insulating material, resistant to high temperatures, preferably mica-based.

6. The exhaust valve according to claim 1, wherein said at least one thermal decoupler comprises at least one thermal insulating material.

7. The exhaust valve according to claim 6, wherein the thermal insulating material is a fiber mat made of a material chosen between glass or ceramic.

8. The exhaust valve according to claim 1, wherein said at least one thermal decoupler comprises an air gap in which no exhaust gas flows.

9. The exhaust valve according to claim 1, wherein the tubular body is thinned with respect to the proximal and/or distal housing, relative to an average thickness of the tubular body, by a ratio of between 20 and 80%.

10. The exhaust valve according to claim 1, wherein the tubular body is thinned with respect to the proximal and/or distal housing, relative to an average thickness of the tubular body, by a ratio of between 30 and 60%.

11. The exhaust valve according to claim 1, wherein the tubular body is thinned with respect to the proximal and/or distal housing, relative to an average thickness of the tubular body, by a ratio of 50%.

12. The exhaust valve according to claim 1, wherein the proximal and/or distal housing is extended by a cooling fin.

13. The exhaust valve according to claim 12, wherein the cooling fin is disc-shaped.

14. The exhaust valve according to claim 12, wherein the cooling fin is perpendicular to the axis of rotation.

15. The exhaust valve according to claim 1, wherein the proximal and/or distal housing is made of a highly heat-conductive material.

16. The exhaust valve according to claim 1, wherein the proximal housing has a large contact surface with the rotary actuator and/or with a support of the rotary actuator.

17. The exhaust valve according to claim 1, wherein the shaft is hollow and at least one of the proximal and distal ends of the shaft opens out of the tubular body.

18. The exhaust valve according to claim 1, wherein the proximal and/or distal housing has an opening suitable for placement of a bearing, said opening being directed away from the tubular body.

19. The exhaust valve according to claim 1, wherein the proximal bearing and/or the distal bearing comprises a self-lubricating graphite, PTFE, or bronze bearing.

20. An exhaust line comprising the at least one exhaust valve according to claim 1.

21. A vehicle comprising the exhaust line according to claim 20.
